(19) United States
(12) Patent Application Publication
(10) Pub. No.: US 2025/0389342 A1
(43) Pub. Date: Dec. 25, 2025

(54) VALVE BLOCK BODY AND FITTING ASSEMBLY

(71) Applicant: GEMÜ Gebr. Müller Apparatebau GmbH & Co. Kommanditgesellschaft, Ingelfingen (DE)

(72) Inventors: Christian Dasbach, Heilbronn (DE); Robin Roos, Holzhäusern (CH); Daniel Vogt, Neuenstein (DE)

(21) Appl. No.: 19/247,749

(22) Filed: Jun. 24, 2025

(30) Foreign Application Priority Data
Jun. 25, 2024 (DE) 10 2024 117 850.7

(51) Int. Cl. F16K 27/00; F16K 7/12; F16K 27/02

(52) U.S. Cl. CPC F16K 27/003; F16K 7/12; F16K 27/0236

(57) ABSTRACT

A valve block body includes a monolithic main body formed by additive manufacturing and comprising a plurality of base portions with valve seats accessible via seat openings, a plurality of fastening portions, a plurality of process fluid connections, and a plurality of tubular walls defining internal fluid channels. A biomimetic structure connects the base portions, fastening portions, and tubular walls, and includes features such as variable density, hierarchical branching, and alignment along primary force paths to optimize strength and reduce material usage. The structure can include clamping force transmission portions and tubular support portions. Valve diaphragms can be provided to close the seat openings. The main body can further include a plate-shaped support contour and an outer housing. A fitting assembly includes the valve block body and a drive carrier with valve actuators and movable clamping elements for securing the valve block body during operation.

### TECHNICAL FIELD

The present disclosure relates generally to fluid handling systems, and more particularly to valve block bodies and fitting assemblies for use in process applications. In particular, the disclosure concerns integrally formed valve block structures suitable for single-use, high-purity environments such as pharmaceutical, biotechnological, or medical processing systems.

### BACKGROUND

Single-use components, such as valve blocks, are typically employed in high-purity environments including pharmaceutical or biotechnological processing, where contamination prevention is critical. These components are designed to be used once and disposed of after operation to eliminate cleaning requirements and reduce cross-contamination risks.

Conventional valve block bodies are often constructed from multiple assembled parts, which can complicate manufacturing and introduce potential leakage paths or structural weaknesses. There remains a need for an integrally formed valve block body that ensures robust mechanical support, optimized material use, and compatibility with single-use, high-purity operating conditions.

### SUMMARY

One aspect of the present disclosure relates to a valve block body comprising a monolithic main body, wherein the monolithic main body comprises: a plurality of base portions having a valve seat, wherein the valve seats are accessible via a particular seat opening of the associated base portion; a plurality of fastening portions; a plurality of process fluid connections; a plurality of tubular walls, each of which delimits an interior space of a particular process fluid channel extending from the particular seat opening towards at least one of the process fluid connections and/or towards at least one other of the seat openings; and a biomimetic structure which connects the base portions, the fastening portions, and the tubular walls to one another.

As used herein, the term “biomimetic” refers to structures that imitate or are inspired by biological forms or patterns, such as those found in nature. These structures often exhibit optimized strength-to-weight ratios and efficient material distributions based on evolutionary principles. The biomimetic lattice or arm structure saves material compared to, for example, solid material valve blocks, which not only results in cost benefits but also improves the environmental impact, particularly in the single-use sector. The lattice or arm structure, inspired by natural structures, enables an optimal combination of structural stability and material savings. The interconnected components form a functional, monolithic main body that can be manufactured using additive production methods.

In some aspects of the present disclosure, the biomimetic structure has a variable density, wherein the density of the biomimetic structure is defined as the ratio of structural material to cavity per unit volume and is adapted to the local mechanical requirements, wherein the biomimetic structure has regions of increased density near the valve seats, the process fluid connections and/or the fastening portions and regions of reduced density between the valve seats, and/or between the process fluid connections and/or between the fastening portions.

Advantageously, the variable density of the structure allows for an optimal distribution of the material according to the local loads. More material is used in regions with higher mechanical stress, while material is saved in less stressed regions. The bionic optimization of the valve body enables weight savings in a range between 20% and 90% in comparison to the prior art, for example a milled block. This yields an improved strength-to-weight ratio and minimizes material usage in the single-use sector, which further improves the environmental impact.

In one aspect of the present disclosure, the monolithic main body comprises a hierarchical support structure, in particular in the form of the biomimetic structure, in which main support elements branch into smaller support structures, wherein the support structures have a biomimetic branching pattern that is modeled on a natural tree branch structure.

This hierarchical support structure that is inspired by natural tree branch structures enables efficient force transmission and load distribution within the valve block body. The branches of the support structure follow biomimetic principles and ensure optimal stability with minimal use of material. By imitating natural structures, local stress peaks are avoided, and the mechanical load capacity of the valve block body is increased.

In some aspects of the present disclosure, the biomimetic structure forms a three-dimensional network of interconnected structural elements which stabilizes the tubular walls in different spatial directions, wherein the biomimetic structure has an orientation of the structural elements along the main force flows during operation.

Using the three-dimensional arrangement of the structural elements along the main force flows, optimal mechanical stability is achieved. The orientation of the structural elements follows the loads occurring during operation and ensures efficient force transmission throughout the entire valve block body. This load-path-optimized arrangement of the structural elements leads to greater rigidity and strength while simultaneously reducing material usage.

In one aspect of the present disclosure, at least two adjacent tubular walls are spaced apart from each other at least partially by a continuous cavity so that a skeletal structure of the biomimetic structure results between the tubular walls.

This skeletal arrangement results in significant material savings while at the same time ensuring mechanical stability. The continuous cavity between adjacent tubular walls reduces the overall weight of the valve block body and improves material efficiency. The skeletal structure of the structure acts as a lightweight but high-strength load-bearing element.

In some aspects of the present disclosure, the biomimetic structure comprises tubular support portions that are formed as part of the biomimetic structure and that connect the tubular walls to the fastening portions.

Using the integration of the tubular support portions into the biomimetic structure, a direct transmission of force between the tubular walls and the fastening portions is enabled. This structural connection increases the stability of the valve block body and prevents unwanted deformations of the tubular walls during operation. The tube support portions form an integral component of the structure and contribute to the overall stability.

In one aspect of the present disclosure, the biomimetic structure comprises clamping force transmission portions which are formed as part of the biomimetic structure and connect the fastening portions to the base portions in order to enable a transmission of fastening force, in particular a transmission of clamping force.

Using the clamping force transmission portions, a uniform distribution of the forces that occur when fastening the valve block body is advantageously ensured. The clamping forces introduced into the fastening portions are efficiently transferred to the base portions, which results in a stable and secure fastening of the valve block body. The integration of the clamping force transmission portions into the biomimetic structure ensures a harmonious interaction of all components and improves the reliability of the fastening.

In some aspects of the present disclosure, the valve block body comprises a plurality of valve diaphragms which each close a particular one of the seat openings of the monolithic main body.

The valve diaphragms enable a reliable controlling of the fluid flow through the valve block body. By closing the seat openings, a precise regulation of the process fluid is achieved. The valve diaphragms are designed to interact optimally with the biomimetic structure of the valve block body and ensure efficient function of the valves.

In some aspects of the present disclosure, the tube support portions and clamping force transmission portions are formed by a network of connecting elements and nodes with variable density, wherein the density is defined as the ratio of structural material to cavity per unit volume and/or as the number of connecting elements per unit volume, wherein the density of the network is higher in the region of the connections to the fastening portions and in the region of the connections to the base portions than in the central region of the tube support portions and clamping force transmission portions.

Using the higher density in the connection regions, a robust connection between the various components of the valve block body is ensured. This compaction in regions subject to higher mechanical stress optimizes the transmission of force and prevents local weak points. At the same time, the lower density in the central region of the support portions saves material without compromising the structural integrity. The variable density is therefore a central element of the biomimetic optimization.

In one aspect of the present disclosure, a continuous or partially continuous plate-shaped contour extends between the tubular walls, wherein the plate-shaped contour is located between the process fluid connections and the base portions, wherein the plate-shaped contour is part of the biomimetic structure, or the biomimetic structure adjoins the plate-shaped contour.

The plate-shaped contour provides additional structural stability and improves the mechanical integrity of the valve block body. Using its integration into or connection with the biomimetic structure, a coherent structural system is created that optimizes the load transfer between the various elements of the valve block body. In addition to the pure supporting function, the plate-shaped contour can also be used to subdivide functional regions in the valve block body.

In one aspect of the present disclosure, the fastening portions are arranged in a space between the process fluid connections and the base portions.

This spatial arrangement of the fastening portions enables optimal force introduction and force distribution in the valve block body. The position between the process fluid connections and the base portions ensures a short and direct force flow between the fastening points and the functional elements of the valve block body. This ensures high stability and reliability of the fastening, which is particularly important for the precise function of the valves.

In some aspects of the present disclosure, a first ratio of the material to a cavity per unit volume of a first volume, delimited by an outer shell of the base portions and the fastening portions, is at least 10%, in particular at least 20%, greater than a second ratio of the material to a cavity per unit volume of a second volume, which is delimited either by the process fluid connections and the outer boundary of the fastening portions or by the plate-shaped contour and the outer boundary of the fastening portions.

Using this defined ratio, an optimal material distribution is achieved in the valve block body. The higher material density in the region of the base portions and fastening portions ensures the necessary stability in these regions subject to high mechanical stress. At the same time, material is saved in the less stressed regions, which leads to a reduction in weight and an improvement in the environmental impact. This precise coordination of material distribution is a key element of the biomimetic design approach.

In one aspect of the present disclosure, the base body comprises at least one contact surface for the valve block body to lie against a drive carrier, and the plurality of fastening portions which each comprise a particular clamping surface facing away from the at least one contact surface for engaging a clamping device of the drive carrier, wherein the particular base portion provides the at least one contact surface for lying against the drive carrier.

This configuration enables a stable and precise fastening of the valve block body to the drive carrier. The contact surface ensures a defined positioning, while the clamping surfaces of the fastening portions ensure secure fixation by the clamping device. By directly providing the contact surface through the base portions, a direct force transmission between the drive carrier and the functional valve elements is achieved, which improves the precision of the valve controlling.

In some aspects of the present disclosure, at least one clamping force transmission portion of the monolithic main body connects one of the fastening portions and one of the base portions adjacent to the one fastening portion to one another, wherein the particular base portion provides the at least one contact surface for lying against the drive carrier.

Advantageously using his arrangement, a direct and efficient transmission of the clamping forces from the fastening portion to the base portion is enabled. The forces thus introduced press the base portion with its contact surface uniformly against the drive carrier, which results in a stable and reliable connection. This direct force transmission minimizes deformations and improves the precision of the valve control.

In one aspect of the present disclosure, at least one of the fastening portions is located between a first and a second of the base portions, wherein at least a first of the clamping force transmission portions connects the at least one fastening portion and the first base portion to one another, and wherein at least a second of the clamping force transmission portions connects the at least one fastening portion and the second base portion to one another.

This configuration allows for a uniform distribution of clamping forces over multiple base portions. Using the central position of the fastening portion between two base portions and the connection via separate clamping force transmission portions, a balanced introduction of force is achieved. This leads to improved stability and prevents uneven loads that could lead to deformations or functional impairments.

In some aspects of the present disclosure, a particular one of the base portions of the monolithic main body comprises the valve seat; the seat opening through which the valve seat is accessible; a diaphragm recess surrounding the seat opening for receiving a lateral portion of the associated valve diaphragm; and at least one portion of the contact surface which surrounds the particular diaphragm recess at least partially.

This integrated design of the base portion combines all functional elements of a valve in one compact unit. The close proximity of the valve seat, seat opening, diaphragm recess and contact surface enables precise alignment of the valve components and an optimal transmission of force from the drive carrier to the valve diaphragm. The surrounding contact surface ensures stable fastening and prevents deformations in the region of the diaphragm recess.

In one aspect of the present disclosure, the main body comprises at least partially an outer housing which surrounds the biomimetic structure of the main body at least partially.

The outer housing provides additional protection for the internal biomimetic structure and improves the external appearance of the valve block body. It can protect against external influences and at the same time make cleaning easier. The advantages of the internal structure, such as material savings and optimized force transmission, are retained while creating a closed outer shell for practical and aesthetic purposes.

In some aspects of the present disclosure, the biomimetic structure comprises a network of interconnected connecting elements and nodes, wherein the connecting elements are rod-or plate-shaped elements, and the nodes are connection points at which at least two, in particular three connecting elements meet.

This network structure forms the basic principle of the construction of the biomimetic structure. The connecting elements as load-bearing elements and the nodes as connection points together form a load-optimized structure that is inspired by natural structures. By requiring that at least two, and in particular at least three, connecting elements meet at each node, a stable spatial structure is created that can absorb forces in different directions. This network structure enables an optimal balance between material efficiency and mechanical stability.

A fitting assembly comprises a valve block body according to one of the previous examples and a drive carrier with a plurality of valve drives, wherein in a first state, a plurality of movable clamping elements, supported on the drive carrier, of a clamping device release an assembly space for arranging the valve block body on the drive carrier, and wherein in a second state, the plurality of clamping elements introduce a clamping force into the valve block body via the fastening portions of the valve block body and clamp the valve block body between the plurality of clamping elements and the drive carrier.

This fitting assembly enables easy and quick replacement of the valve block body, which is particularly advantageous in the single-use sector. Using the defined assembly space in the first state, easy positioning of the valve block body is enabled, while in the second state, secure and precise fixation is ensured by the clamping elements. The uniform introduction of the clamping forces via the fastening portions ensures a stable connection without local overloads.

In some aspects of the present disclosure, the plurality of the clamping elements can be actuated via a control carrier which is movable relative to the valve block body carrier and on which the valve drives are rigidly arranged, and wherein the at least one clamping drive introduces its drive force into the control carrier for its movement.

This configuration enables synchronized movement of all clamping elements using a single control carrier, which simplifies operation and increases the reliability of the clamping. The rigid arrangement of the valve drives on the control carrier ensures a precise positioning relative to the valve block body. By introducing the drive force into the control carrier, a uniform distribution of force is achieved across all clamping elements, which leads to homogeneous clamping of the valve block body.

A further aspect of the description relates to a valve block body. This comprises a monolithic main body, wherein the monolithic main body comprises a plurality of base portions with a respective valve seat, wherein the valve seats are accessible via a respective seat opening of the associated base portion, wherein the monolithic main body comprises at least one in particular flat contact surface for the valve block body to lie against a drive carrier, wherein the monolithic main body comprises a plurality of process fluid connections; and wherein the monolithic main body comprises a plurality of tubular walls, each of which delimits an interior space of a respective process fluid channel extending from the respective seat opening towards at least one of the process fluid connections and/or towards at least one other of the seat openings.

Using the tubular walls, material is saved compared to solid material valve blocks, which not only results in cost advantages but also improves the environmental impact, in particular in the single-use sector. Using the topology optimization, cost advantages also result due to material savings and the corresponding advantages in manufacturing.

If the main body is manufactured using an additive production method, further advantages result. In this way, sharp edges in the media contact region can be prevented. In this way, flow-optimized valve block bodies can be manufactured. Dead volumes can also be reduced.

In some aspects of the present disclosure, at least two adjacent tubular walls are spaced from each other at least partially by a cavity.

Advantageously, there is no material between the tubular walls for the process fluid channels, which improves the environmental impact.

In some aspects of the present disclosure, the valve block body comprises a plurality of valve diaphragms which each close one of the seat openings of the monolithic main body.

Advantageously, in this way, a series of diaphragm valves are provided using a valve block body.

In some aspects of the present disclosure, at least one tube support portion of the monolithic main body connects at least two adjacent tubular walls to each other.

This advantageously improves the stability of the valve block body.

In some aspects of the present disclosure, each base portion provides the at least one, in particular flat, contact surface for lying against the drive carrier, wherein the monolithic main body comprises a plurality of fastening portions which each comprise a clamping surface facing away from the at least one contact surface for engaging a clamping device of the drive carrier.

Advantageously, this allows a single drive carrier to be used which comprises the drives for moving the valve diaphragms.

In one aspect of the present disclosure, at least two adjacent fastening portions are spaced from each other at least partially by a cavity.

The fastening portions spaced apart by the cavity enable material savings.

In some aspects of the present disclosure, at least one tube support portion of the monolithic main body connects one of the fastening portions and one of the tubular walls.

This advantageously improves the stability of the valve block body. In particular, tubular walls that protrude far from the base portions can be better supported in this way.

In one aspect of the present disclosure, at least one clamping force transmission portion of the monolithic main body connects one of the fastening portions and one of the base portions adjacent to the one fastening portion.

Advantageously, in this way the clamping force introduced into the fastening portion can be introduced into the base portion in order to press the base portion onto the drive carrier via the contact surface.

In some aspects of the present disclosure, the fastening portion provides a part of the contact surface.

Advantageously, the entire fastening portion thus forms a monolithic structure which improves the clamping of the valve block body.

In some aspects of the present disclosure, at least one of the fastening portions is located between a first and a second of the base portions, wherein at least a first of the clamping force transmission portions connects the at least one fastening portion and the first base portion to one another, wherein at least a second of the clamping force transmission portions connects the at least one fastening portion and the second base portion to one another.

Advantageously, the clamping force introduced into the monolithic main body is thus transferred to at least two adjacent base portions. This ensures uniform clamping of the valve block body.

In one aspect of the present disclosure, one of the respective base portions of the monolithic main body comprises: the valve seat; the seat opening through which the valve seat is accessible; a diaphragm recess surrounding the seat opening for receiving a lateral portion of the associated valve diaphragm; and at least one portion of the contact surface which surrounds the respective diaphragm recess at least partially.

Advantageously, the valve diaphragm can be received with its lateral region in the recess in order to close the seat opening.

In some aspects of the present disclosure, the main body comprises an outer housing which surrounds cavities of the main body.

In addition to a clean appearance, the housing helps to improve the assembly and handling of the valve block body while retaining the cavities in the interior. In addition, stability is improved.

One aspect of the present disclosure relates to a fitting assembly comprising a valve block body, in particular according to the first aspect. The fitting assembly further comprises a drive carrier with a plurality of valve drives, wherein in a first state, a plurality of movable clamping elements of a clamping device supported on the drive carrier release an assembly space for arranging the valve block body on the drive carrier, and wherein in a second state, the plurality of clamping elements introduce a clamping force into the valve block body via the fastening portions of the valve block body and clamp the valve block body between the plurality of clamping elements and the drive carrier.

In one aspect of the present disclosure, the plurality of the clamping elements can be actuated via a control carrier which is movable relative to the valve block body carrier and on which the valve drives are rigidly arranged, wherein the at least one clamping drive introduces its drive force into the control carrier for its movement.

In some aspects of the present disclosure, the valve drives are rigidly arranged on the valve block body carrier, wherein the plurality of the clamping elements are each movable via a clamping drive fixed on the valve block body carrier, wherein the clamping elements each move into a recess of the clamping portion during the transition to the second state.

Further details and aspects of the disclosure can be found in the following description, by which aspects of the disclosure are further described and explained.

### BRIEF DESCRIPTION OF THE DRAWINGS

Further advantages and aspects of this disclosure emerge from the claims and from the following description of preferred exemplary aspects of this disclosure, which are explained below with reference to the figures. Identical and functionally corresponding elements are provided with identical reference signs. In the drawings:

FIG. 1 is a valve block body shown in perspective view;

FIG. 2 is a main body of the valve block body of FIG. 1 in a view of valve seats;

FIG. 3 is a fitting assembly comprising the valve block body according to FIG. 1 in a perspective view;

FIG. 4 is the fitting assembly of FIG. 3 is in a side view;

FIG. 5 is the main body of a second example of the valve block body in a sectional view;

FIG. 6 is the main body of FIG. 5 in a side view;

FIG. 7 is the valve block body according to the second example in a perspective view;

FIG. 8 is a second example of the fitting assembly with the valve block body of FIG. 7;

FIG. 9 is the main body of a third example of the valve block body in a perspective view;

FIG. 10 is the main body of FIG. 9 in a longitudinal sectional view;

FIG. 11 is another example of the valve block body; and

FIG. 12 is another example of the fitting assembly with the valve block body from FIG. 11.

### DETAILED DESCRIPTION

Existing valve block bodies, especially in high-purity and single-use sectors, often rely on solid construction that results in unnecessary material consumption, high weight, and manufacturing limitations. These configurations are poorly suited to additive manufacturing methods and provide suboptimal structural efficiency. Accordingly, there remains a need for a valve block body that minimizes material use while maintaining high mechanical stability and compatibility with disposable system requirements.

As used herein, a “clamping force transmission portion” refers to a section of the biomimetic structure that mechanically couples a fastening portion to a base portion and is configured to transmit clamping forces introduced by a clamping device. These portions enable effective transfer of mechanical load during installation, ensuring the valve block body is securely fastened to a carrier without undesired deformation.

As used herein, a “tubular support portion” refers to an integral structural element of the biomimetic structure that spans between a tubular wall and a fastening portion, providing mechanical reinforcement and preventing deflection or displacement of extended tubular walls during use.

As used herein, a “plate-shaped contour” refers to a generally planar or partially planar structural feature that spans between multiple components of the valve block body, such as the base portions and process fluid connections. It contributes to the stiffness and load distribution of the monolithic main body.

As used herein, “material-to-cavity ratio” defines the volumetric ratio of solid structural material to internal cavity volume within a defined region of the valve block body. This metric is used to evaluate and optimize structural density relative to the load-bearing demands of different zones.

As used herein, a “fitting assembly” refers to a system comprising the valve block body and a cooperating drive carrier that includes one or more valve drives and a clamping mechanism. The fitting assembly is configured such that in a first state, the clamping elements permit placement or removal of the valve block body, and in a second state, the clamping elements apply force to secure the valve block body in an operational position.

As used herein, a “suspension” includes one or more integrally formed structural features, such as a tab and associated through-opening, configured to allow hanging, securing, or aligning of the valve block body within a larger system or fixture. The suspension can be used for handling, alignment, or mounting purposes.

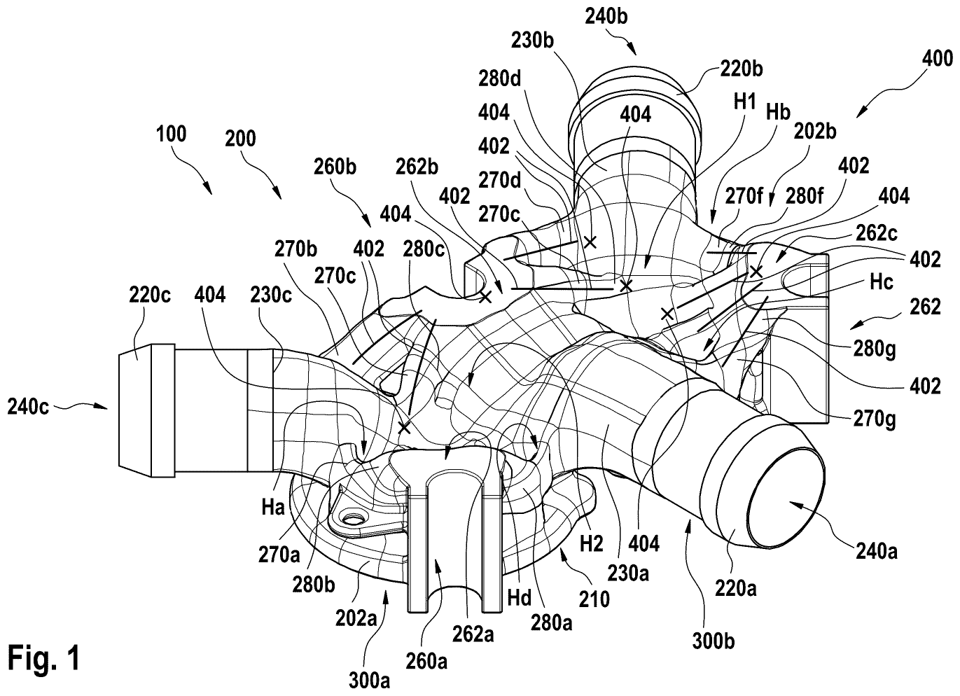

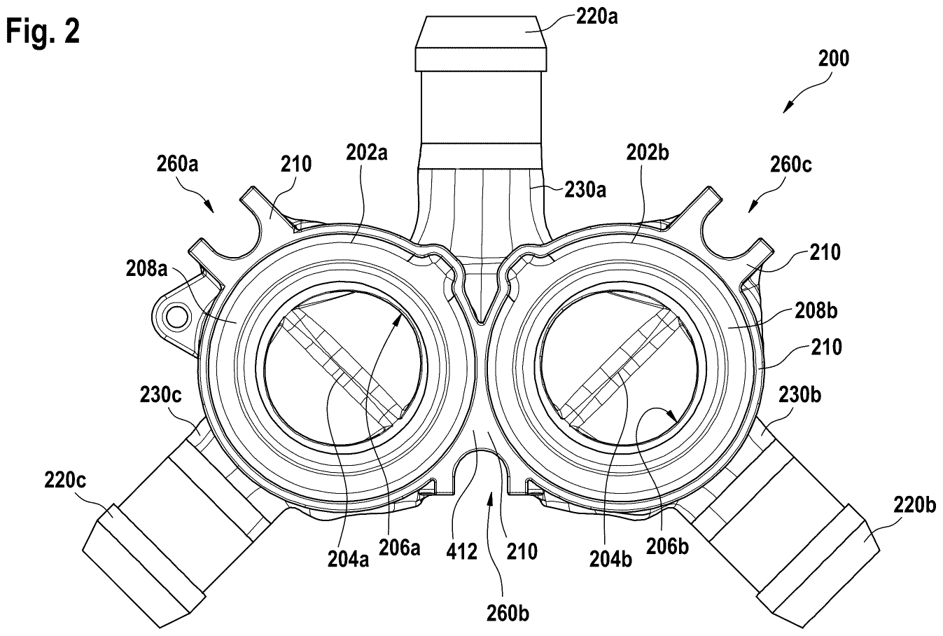

FIG. 1 shows a perspective view of a valve block body 100 for a fitting assembly in process fluid engineering. In FIG. 2, the main body 200 is shown with a view of a contact surface 210.

The valve block body 100 comprises a monolithic main body 200. The main body 200 is made of a plastic such as polyamide, polypropylene, a thermoplastic polyurethane or another plastic. For example, the main body 200 can be manufactured using an additive production method.

The valve block body 100 is designed for a single-use application so that it is to be disposed of after a single use. The valve block body 100 is therefore disposed of after the completion of a so-called batch, e.g., the passage once or multiple times of a process fluid of a batch. The valve block body 100 with its monolithic main body 200 is therefore designed such that it has material only where it is needed to maintain the function of the valve block body 100.

The main body 200 has a biomimetic structure 400. With respect to the valve block body 100 described in the present application, “biomimetic” means that the structure is inspired by and mimics natural, biological structures and principles. Nature has undergone evolutionary processes over millions of years and developed structures in the process that offer maximum stability and functionality with minimal use of materials. Concrete examples of biomimetic structures that are used in the valve body 100:

Bone structures (trabecular structure): bones consist of an outer dense shell and an inner light but stable lattice network (trabecular meshwork) that is optimally adapted to the loads that occur.

Tree branch structures: the branches of trees follow specific patterns that enable efficient force distribution. Thicker main branches branch into increasingly thinner branches, with the branching angles and diameters following a biomechanical optimization.

Cellular structures in plants: plant stems or leaves often have internal support structures that ensure high flexural rigidity with low material usage.

The biomimetic structure 400 can therefore also be described as a lattice structure or arm structure.

In the context of the description, the biomimetic design of the valve block body 100 means that the structure 400 mimics these natural principles by:
Using material where it is needed for structural integrity and saving it where it is less important
Using hierarchical structures with main and secondary elements
Optimizing load paths by aligning structural elements along the main load directions
Having variable densities depending on local mechanical requirements

This biomimetic approach results in the described valve block body 100 which has sufficiently good mechanical properties with minimized material usage, which contributes to an improved environmental impact, particularly in the single-use sector, due to the material savings. The monolithic main body 200 is manufactured, for example, using an additive production method.

A plurality of valve diaphragms 300a-b closes a respective one of a plurality of seat openings of the monolithic main body 200. The valve block body 100 thus comprises the main body 200 and the valve diaphragm 300a-b which are connected to the main body 200 in their lateral region for example by a material bond. The valve diaphragms 300a-b as well as the seat openings closed by the valve diaphragms 300a-b are arranged on a single side of the valve block body 100, namely on the drive side.

Of course, aspects are also conceivable in which the valve diaphragms and thus also the valve drives are arranged on the valve block body distributed over multiple, e.g., at least two, sides. For example, walls tilted at 45° to each other can be provided for the arrangement of the valve drives or valve diaphragms.

A respective base portion 202a-b of the monolithic main body 200 comprises a valve seat 204 and the seat opening 206 through which the valve seat 204 is accessible.

In addition, the base portion 202a-b comprises a diaphragm recess 208a-b surrounding the seat opening 206a-b for receiving a lateral portion of the associated valve diaphragm 300a-b. The respective valve seat 204a-b is accessed via the associated seat opening 206a-b of the base portion 202a-b. The valve seat 204a-b is arranged between two process fluid channels, thus separating them from each other.

In the example shown, the valve seat 204a-b is designed in the manner of a connecting element. In an example (not shown), at least one of the valve seats is annular, wherein a plug diaphragm with a rotationally symmetrical convex sealing contour presses on the associated annular valve seat to interrupt the fluid flow.

The base portion 202a-b comprises at least a portion of the flat contact surface 210. The at least one portion of the flat contact surface 210 surrounds the particular diaphragm recess 208 at least partially. In one example, the contact surface 210 is continuous and touches all base portions 202-b. In another example (not shown), the contact surface 210 is interrupted partially.

The respective base portion 202a-b, together with the associated valve diaphragm 300a-b, represents a valve unit of the valve block body 100, using which a flow of process fluid through the valve block body 100 is set or regulated by adjusting the position of the respective valve diaphragm 300a-b in relation to the fixed valve seat 204a-b.

The contact surface 210, which is at least partially flat, is designed so that the valve block body 100 can continuously lie against an associated drive carrier. Thus, during operation of the fitting assembly, the respective base portion 202a-b rests with its respective or continuous contact surface 210 on the rest of the fitting assembly.

To apply a clamping force to the contact surface 210 in the direction of the drive carrier, the monolithic main body 200 comprises a plurality of fastening portions 260a-c that are spaced apart from each other. In the example, the fastening portions 260a-c are each arranged between two of the process fluid connections 220a-c. The fastening portions 260a-c can therefore also be specifically designated as clamping portions.

The respective portion 260a-c comprises a clamping surface 262a-c facing away from the at least one contact surface 210 of the main body 200. A clamping device supported on the drive carrier transmits its clamping force into the valve block body 100 via the clamping surface 262a-c. The valve block body 100 introduces the clamping force into the drive carrier, against which the valve block body 100 lies with its contact surface 210. This clamps and secures the valve block body 100 between the clamping device and the drive carrier.

Between one of the fastening portions 260a-c and a plurality of tubular walls 230a-c there is, at least partially, a continuous recess Ha-d, e.g., an empty space.

A respective tubular wall 230a-c connects, at least partially, one of the process fluid connections 220a-c to at least one base portion 202a-b. The tubular wall 230a-c delimits, with its interior space, a process fluid channel that connects at least one process fluid connection 220a-c to at least one seat opening 206a-b.

In the present case, for example, the process fluid connection 220a is connected to the two seat openings 206a and 206b. The process fluid connection 220b is connected to the seat opening 206b. The process fluid connection 220c is connected to the seat opening 206a.

Of course, depending on the application, other fluid-conducting connections between process fluid connections 220 as well as with seat openings 206 are also conceivable.

A respective tubular wall 230a-c comprises, at least partially, a tubular outer surface which extends along a central longitudinal axis of the associated process fluid channel. The course is not limited to straight extensions. The tubular wall 230a-c partially follows curved imaginary lines, along which the respective process fluid channel extends.

The monolithic main body 200 comprises the plurality of process fluid connections 220a-c, cach of which leads into an interior of the associated tubular wall 230a-c. The interior space of the respective tubular wall represents the associated process fluid channel 240a-c which, in the example of FIGS. 1 and 2, leads from the process fluid connection 220a-c to at least one scat opening 206a-b.

A respective continuous cavity H1 is arranged in at least one direct path between two adjacent tubular walls 230a, 230b and 230a, 230c.

Two adjacent fastening portions 260a, 260b or 260b, 260c are spaced from each other at least partially by the continuous cavity H1, H2.

A clamping force transmission portion 280a, 280b connects the fastening portion 260a to the base portion 202a.

FIG. 1 shows, by way of example, that the clamping force transmission portion 280a-g projects in each case obliquely from the clamping surface 262a-c in the direction of the associated base portion 202a-b.

The clamping force transmission portion 280a protrudes, for example, from the fastening portion 260a in the direction of the diaphragm recess 208a of the associated base portion 202a. This also ensures that the lateral region of the particular valve diaphragm 300a is securely clamped between the main body 200 and the drive carrier.

In the example, the respective fastening portion 260a-c provides a part of the contact surface 210. In the example, the contact surface 210 is provided by the fastening portions 260a-c and the regions of the base portions 202a-b that surround the diaphragm recess 208a-b.

At least one of the fastening portions 260a-c directly adjoins one of the base portions 202a-b. Advantageously, the valve block body 100 is thereby smaller, and material is saved. On the other hand, the clamping force can be introduced into the valve block body 100 close to the contact surface 210.

The fastening portion 260b is arranged between the first and second of the base portions 202a, 202b. A first of the clamping force transmission portions 280c connects the at least one fastening portion 260b and the first base portion 202a to each other. A second of the clamping force transmission portions 280d connects the at least one fastening portion 260b and the second base portion 202b to each other.

In FIG. 1 it can be seen that the monolithic main body 200 of the valve block body 100 has the biomimetic structure 400 that extends between the tubular walls 230a-c and the visible cavities H1, H2. The biomimetic structure 400 consists of a three-dimensional network of interconnected connecting elements 402 and nodes 404, wherein the connecting elements 402 are designed as rod-shaped, plate-shaped, or freely shaped elements that meet at the nodes 404.

In FIG. 1, it can also be seen that the density of structure 400 varies, wherein it has a higher density in the vicinity of the base portions 202a-b and fastening portions 260a-c than in the regions between the tubular walls 230a-c. The connecting elements 402 of the structure 400 are oriented along the main force flows that act on the valve block body 100 during operation, thereby ensuring improved force transmission between the fastening portions 260a-c and the base portions 202a-b.

The clamping transmission portions 280a-g are integrated into the structure 400 and form hierarchical support elements that branch from the fastening portions 260a-c to the base portions 202a-b, wherein they have a biomimetic branching pattern that mimics natural tree branch structures.

The topological connectivity of the structure 400 in the region of more heavily loaded regions is formed as follows. At each node 404 in the form of the fastening portions 260, at least three connecting elements 402 meet, with the number of meeting connecting elements being higher in these mechanically more heavily loaded regions, such as the transitions between the fastening portions 260a-c and the clamping force transmission portions 280a-g.

The cavity portion of the structure 400 including the tube portions 230, e.g., of the entire main body, is between 50% and 90% of the total volume, which leads to a significant material savings while at the same time ensuring the maintenance of the structural integrity of the valve block body 100.

The transition structures between the structure 400 and the tubular walls 230 as well as the base portions 202a-b enable uniform force introduction and transmission and avoid local stress peaks. The transition structures consist of the connecting elements 402 that have a thickness gradually increasing towards the respective wall 230 and are radially attached to a respective outer portion of the tubular walls 230.

In the connection region between connecting element 402 and wall 230, there are reinforced nodes with a larger diameter, which serve as primary force introduction points. The transitions have defined rounding radii to minimize notch effects.

The tube support portions are designed as reinforced portions of the structure 400 and form load-path-optimized connections between the walls 230 and the surrounding structure 400. The orientation of the connecting elements 402 in the transition region follows the calculated main clamping directions.

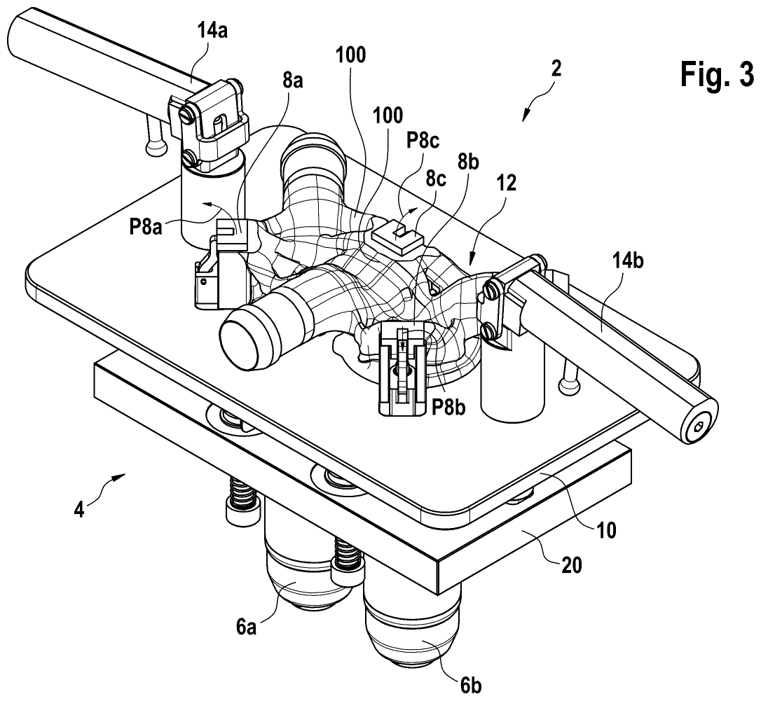

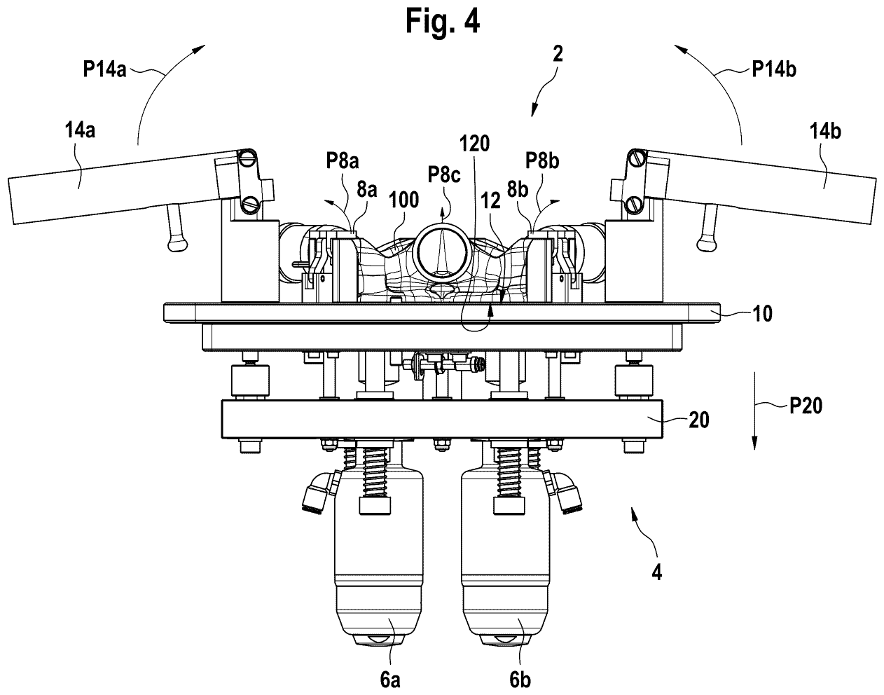

FIGS. 3 and 4 show a fitting assembly or device 2 with the valve block body 100, which is arranged on the drive carrier 4. In the shown operating state, the valve block body 100 is clamped between the clamping device 8 and the drive carrier 4.

A plurality of, in this case two, valve drives 6a-b are arranged on the drive carrier 4. In the shown operating state, the two valve drives 6a-b are each connected in a force-conducting manner to one of the valve diaphragms (not shown). A drive rod (not shown) is moved along a respective actuating axis by the associated valve drive 6a-b. The drive rod is connected in a force-conducting manner to the valve diaphragm and moves the valve diaphragm between an open position in which the process fluid can flow over the valve seat, and a closed position in which the flow of the process fluid is interrupted.

The clamping device 8 comprises movable clamping elements 8a-c. In the shown operating state, the clamping clements 8a-c press the valve block body 100 onto a counter-contact surface 12 of the drive carrier 4 by introducing a clamping force into said body. The valve block body 100 is clamped between the plurality of clamping elements 8a-c and the drive carrier 4. The valve block body 100 lies, at least in the operating state, with its at least one contact surface 210 against a counter-contact surface 12 of a valve block body carrier 10.

In order to remove the valve block body 100 from the drive carrier 4, a manual clamping drive 14a, 14b is used in the example of FIGS. 3 and 4. In a form (not shown), the clamping device 8 can also have a pneumatic or electric motor drive to move the clamping elements 8a-c.

The clamping drive 14 enables the valve block body 100 to be clamped between clamping elements and the associated carrier 4. In addition, the clamping drive 14 moves the valve drive 6a-b between a position in which it is or can be coupled to the associated valve diaphragms 300a-b and a decoupled position.

A movement of the handles of the clamping drive 14a-b according to arrows P14a-b results in a control carrier 20, on which the valve drives 6a-b are arranged, moving away from the valve block body carrier 10 according to an arrow P20. It is assumed that the drive rod is decoupled from the valve diaphragm at the same time or beforehand. On the other hand, the activation of the handles causes the clamping elements 8a-c to move away from the valve block body 100 or the associated fastening portions according to the arrows P8a-c. The valve block body 100 can then be removed from the drive carrier 4, and an assembly space is released. Another new valve block body 100 can be fastened to the drive carrier 4 by first inserting it into the assembly space and then actuating or activating the clamping device 8 for clamping.

In the pre-assembly state, the plurality of clamping elements 8a-c are located in a region facing away from an assembly space in which the valve block body 100 is to be arranged. For assembly and clamping, the clamping elements 8a-c are brought to the valve block body 100 after it has been arranged.

The clamping device 8 is supported on the carrier 10. A subunit of the clamping device 8 comprises an actuating rod which is movably mounted along its longitudinal axis and which is connected via a pivot joint to the associated one of the plurality of clamping elements 8a-c, wherein an element arranged fixed to the carrier 10 engages in an elongated hole of the associated clamping element 8a-c. The elongated hole tapers in the direction of a contact portion of the associated clamping element 8a-c which is designed to engage in the associated clamping portion of the valve block body.

It is provided that a respective adapter of the plurality of valve actuators, which adapter is rigidly connected to a valve rod movable along the actuating axis, releases, in the unassembled state, the assembly space for the arrangement of an associated coupling portion of a diaphragm, wherein the respective adapter, in order to achieve the operating state of the fitting assembly 2, fixes or locks the associated coupling portion of the diaphragm to the actuator rod in a force-conducting manner.

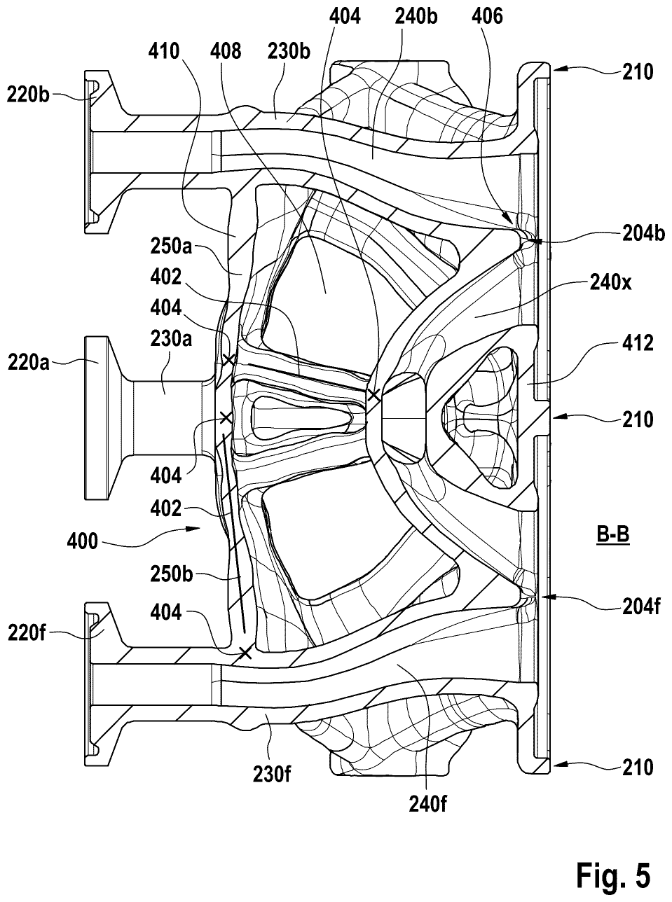

FIGS. 5-7 show a further example of the valve block body 100. In these figures, the valve block body 100 shown here is designed more complex in that the number of valve diaphragms 300, process fluid connections 220 and intermediate elements of the valve block body 100 is increased. According to the different geometry and structure compared to the main body 200 from the previous FIGS. 1-4, a partially different design of the main body 200 results. For analogous features of the valve block body 100, reference is made to the previous figure description which is also applicable to the following FIGS. 5 et seq.

The monolithic main body 200 has the plurality of base portions 202a-e, each with the respective valve seat 204a-e. The valve seat 204a-e is accessible via a respective seat opening 206a-e of the associated base portion 202a-c. The monolithic main body 200 comprises the at least one contact surface 210, in particular having a flat design, for the valve block body 100 to lie against the drive carrier. The monolithic main body 200 comprises the plurality of process fluid connections 220a-f. The monolithic main body 200 comprises the plurality of tubular walls 230a-f, each of which delimits an interior space of a respective process fluid channel extending from the respective seat opening 206a-e toward at least one of the process fluid connections 220a-f and/or toward at least one other of the seat openings 206a-c.

In the example of FIGS. 5-7, in addition to the tubular walls 230a-f which lead to respective process fluid connections 220a-f, there are further tubular walls whose interior space is designed as a process fluid channel and which connect at least two seat openings to one another.

Each of the tube support portions 270a-g projects from the tubular wall in the direction of the associated fastening portion 260a-c.

A first tube support portion 270a-b of the monolithic main body 200 connects at least two adjacent tubular walls 230a, 230b; 230a, 230f to one another, according to Fig.5. The tube support portion 270a-b protrudes from the respective tubular wall 230a, 230b, 230f. In the shown example, the tube support portions 250 a-b form a plate-shaped structure which rigidly fixes to each other portions of the monolithic main body 200 spaced apart from one another by a cavity.

Thus, the tube support portions 270a-b form a plate-shaped structure which, at least partially, follows an imaginary plane parallel to the contact surface 210.

An at least partially continuous plate-shaped first contour 410 extends parallel to and spaced from the course of the base portions 202 between the tubular walls 230a, 230b, 230f, wherein the first plate-shaped contour 410 is located between the process fluid connections 220a, 230b, 2304 and the base portions 202. The first plate-shaped contour 410 here is part of the biomimetic structure 400.

A second plate-shaped contour 412 is formed as part of the biomimetic structure 400 and connects the base portions 202 to one another. This improves the rigidity of the connections of the base portions 202 to each other.

The respective tube support portion 270a-b is designed to support at least one tubular wall 230a-f, e.g., for example to protect it from unwanted bending and damage. For this purpose, the tube support portion 270a-b engages another portion of the monolithic main body 200.

At least one second tubular support portion 270a-d of the monolithic main body 200 connects one of the fastening portions 260a-c and one of the tubular walls 230a-c to each other.

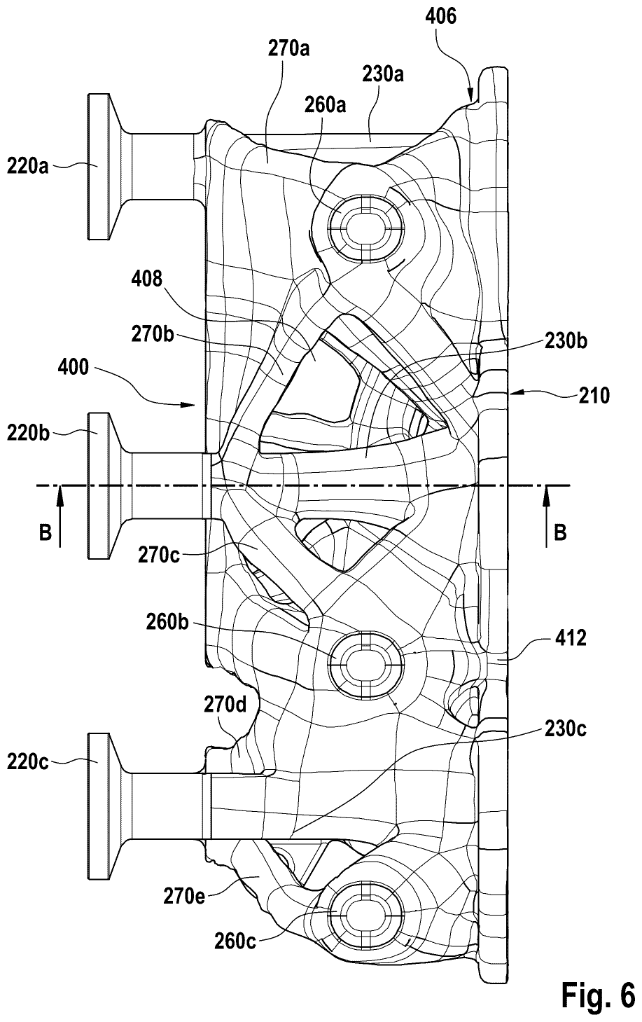

FIG. 6 shows a side view of the main body 200. Openings of the fastening portions 260a-c are visible, which each lead into a respective blind hole.

The fastening portions 260a-c are each connected to a respective wall 230a-c providing a process fluid channel, for example via the tube support portions 270a-e, which extend, partly in a strut-like manner, partly as an edge region of a continuous plate, away from the fastening portion 260a-c.

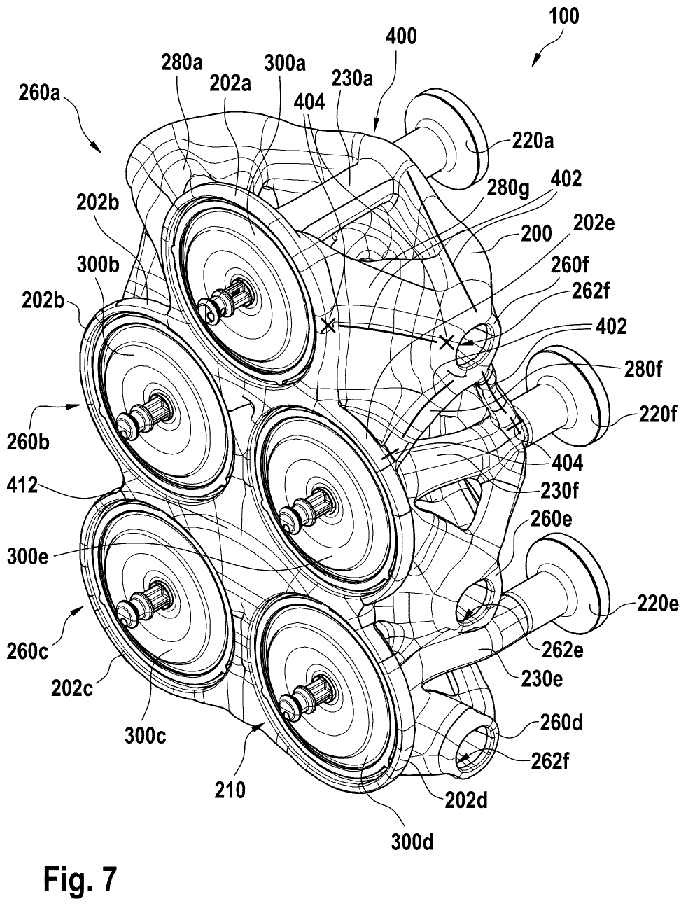

FIG. 7 shows the valve block body 100 of FIGS. 4 and 5 in a perspective view. The valve block body 100 is shown to include the plurality of valve diaphragms 300a-e which close a respective one of the seat openings 206a-e of the monolithic main body 200. The respective valve diaphragm 300a-b; 300a-e is materially bonded by its lateral region to the monolithic main body 200.

It is provided that at least one of the fastening portions 260f, which is designed at least partially as a surface facing away from the contact surface 210, is arranged between two base portions 202a, 202c.

The base portion 202a and the pre-tensioning portion 260f are connected to each other via a respective clamping force transmission portion 280g in order to divert the introduced clamping force towards the base portion 202b. The base portion 202b and the fastening portion 260f are connected to each other via a further clamping force transmission portion 280f.

The clamping force transmission portions 280g and 280f extend in a strut-like manner and/or delimit a common partially plate-shaped structure.

FIGS. 5 to 7 show a more complex (compared to FIG. 1) design of the valve block body 100 with its biomimetic structure 400. The description of the structure 400 in FIG. 1 can be readily transferred to this aspect. In this illustration, the biomimetic structure 400 can be seen particularly clearly between the tubular walls 230a-f and around the fastening portions 260a-f and the base portions 202a-c.

The structure 400 consists of the connecting elements 402 and nodes 404 which form a coherent three-dimensional network. The connecting elements 402 have different cross sections, wherein they have a larger diameter in regions of higher mechanical stress, in particular in the vicinity of the base portions 202a-e and the fastening portions 260a-f , than in a region facing away from the base portion 202a-e and the fastening portion 206a-f.

The nodes 404, at which a plurality of connecting elements 402 meet, are designed to allow a sufficient transmission of force between the connected connecting elements 402.

The geometric arrangement of the structure 400 follows the biomimetic principle, which is inspired for example by trabecular bone structures, wherein the basic pattern of the structure 400 is adapted to the local mechanical requirements. For example, the variable density of the structure 400, which has high-density regions 406 in the vicinity of the valve seats 204a-e and the fastening portions 260a-f, while low-density regions are provided in the less loaded regions 408 between the tubular walls 230a-f.

The structure 400 of the valve block body 100 is represented for example by the clamping force transmission portions 280f and 280g which extend from the fastening portion 260f to the base portions 202a and 202b. This hierarchical structure has at least one main support element that can branch into smaller support structures, for example visible in the connection region to the base portion 202e, wherein the branching angles and diameters are optimized for optimal force transmission.

The topological connectivity of the structure 400 varies across the valve block body 100, with a higher number of connecting elements 402 per node 404 being provided in regions subject to higher mechanical stress.

The cavity portion of the structure 400 also varies, with the volume portion of the material of the valve block body 100 being between 5% and 70% of the total volume of the enveloping cuboid of the valve block body 100.

The mechanical continuity of the structure 400 is ensured by special transition structures between the structure 400 and the other elements of the valve block body 100, wherein these transition structures are particularly clearly visible between the tubular walls 230a-f and the fastening portion 260f. The individual connecting elements 404, with rounded outer contours, are connected around the fastening portion 260f.

The load path optimization of the structure 400 is characterized by the orientation of the connecting elements 402 along the main load directions, which results in an anisotropic structure that is particularly well optimized in the direction of the main loads that act on the valve block body 100 when it is clamped between the clamping device 8 and the drive carrier 4. The main load directions each run, for example, between a base portion 202 and an associated fastening portion 260.

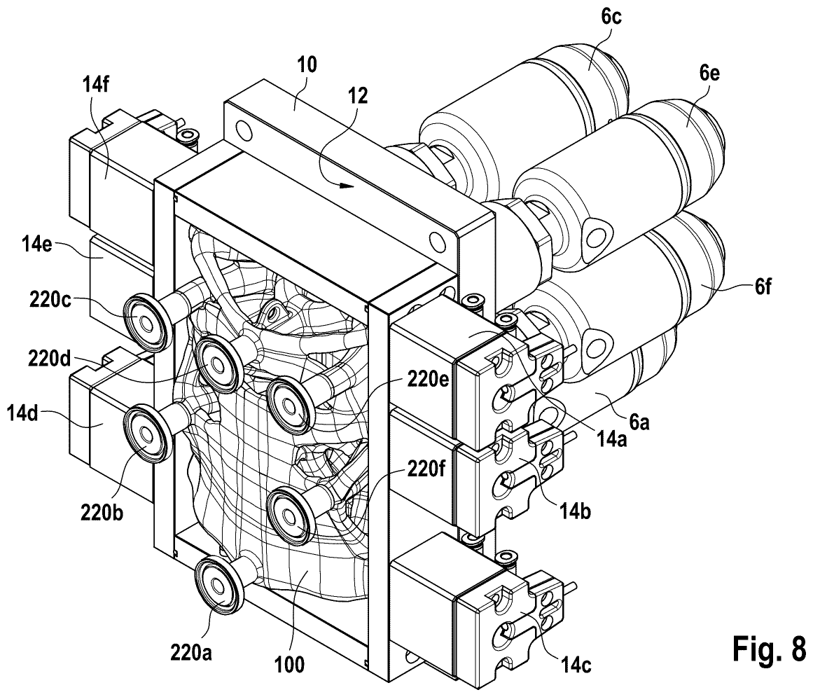

FIG. 8 shows, analogous to FIGS. 3 and 4, the arrangement of the valve block body 100 from FIGS. 5 to 7 as part of the fitting assembly 2. The valve drives 6a-e are rigidly arranged on the carrier 20, wherein the plurality of the clamping elements are each movable via a clamping drive 14a-f fixed to the valve block body carrier 10, and wherein the clamping elements each move into a recess of the clamping portion 260a-f during the transition to the clamped state, i.e. the operating state of the fitting assembly 2.

In the example shown, the valve block body 100 is in the clamped state. In order to reach this state, the clamping elements, which are designed for example as bolts, are inserted into corresponding recesses of the valve block body 100. Before this, the clamping elements release the assembly space for inserting the valve block body 100.

After the insertion of the valve block body 100 into the assembly space, in the example, a respective lever or respective handle of the respective clamping drive 14a-f is pivoted into the position shown in FIG. 8. The pivoting movement of the lever is converted via a gear mechanism into an axial movement of the respective clamping element in order to press, e.g., to clamp, the valve block body 100 against the valve block body 100 via the clamping element and clamping portion 260a-f.

Walls protrude from the carrier 10 and delimit a rectangular inner receiving contour and thus the receiving space or assembly space for the valve block body 100 at least in an imaginary plane.

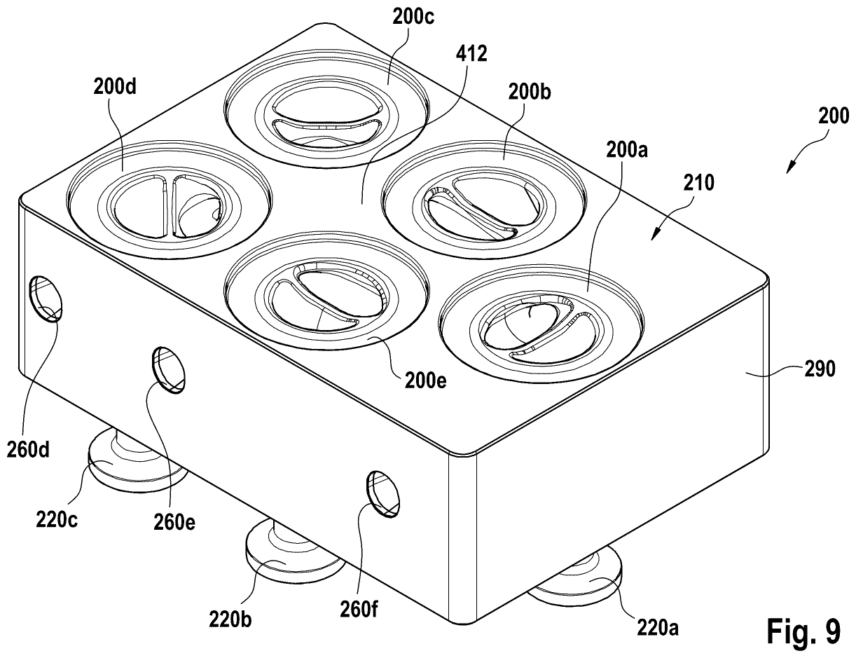

FIG. 9 shows another example of the monolithic main body 200 for the valve block body. In contrast to the previous figures, the main body 201 comprises an outer housing 290 which conceals cavities of the rest of the structure of the main body 201 which are located within the outer housing 92.

In an example (not shown), the monolithic main body does not comprise a closed outer housing, but merely a cover that only partially closes off the component to the outside. The reason is because the process plants are cleaned with spray water from the outside. The cover protects against the ingress of liquids such as water and also contributes to the overall closed appearance.

For example, the cover extends from a region that is provided for contact with the carrier 10 to a cover edge which does not form the end of the main body facing away from the carrier 10. In particular, the cover is circumferential. In this example, the cover indicates to the installer the side that should be connected directly to the carrier 10.

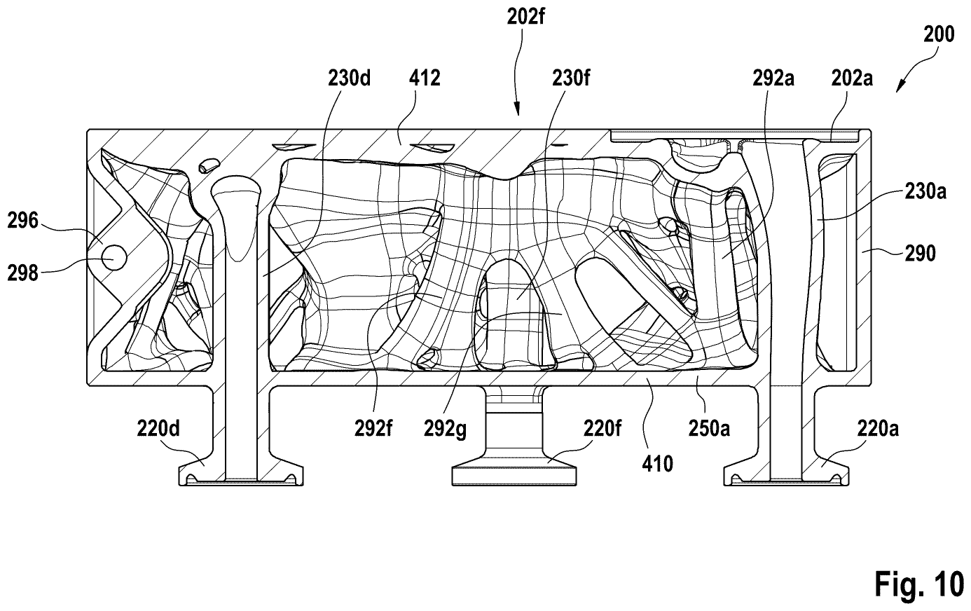

In FIG. 10, the main body 200 is shown in a longitudinal section. The outer housing 290 provides further advantages for the stability of the main body 200 and protects the interior space of the main body 200.

For example, a strut 292a connects a tubular support portion 250a, which connects a plurality of tubular walls 230a, 230f to each other, to the base portion 202a.

In another example, a plurality of separate struts 292f and 292g connect the tube support portion 250a to another base portion 202f. The struts 292f and 292g initially extend separately from one another starting from the tube support portion 250a and merge while extending towards the base portion 202f.

Furthermore, FIG. 10 shows a suspension which comprises a tab 296 of the main body 200 and a through-opening 298 introduced in the tab 296. The provision of the suspension is transferable to all of the above-mentioned aspects.

After the additive manufacturing of the main body 200, the latter is suspended in a vapor deposition chamber using the suspension, for example on a hook whose end extends through the through-opening 298. In the vapor deposition chamber, the main body 200 is treated with steam to smooth the process and function-relevant surfaces of the main body 200.

The continuous plate-shaped contour 410 extends parallel to the course of the base portions 202 between the tubular walls 230a, 230b, 230f, wherein the plate-shaped contour 410 is located between the process fluid connections 220a, 230b, 2304 and the base portions 202. The biomimetic structure 400 adjoins the plate-shaped contour 410.

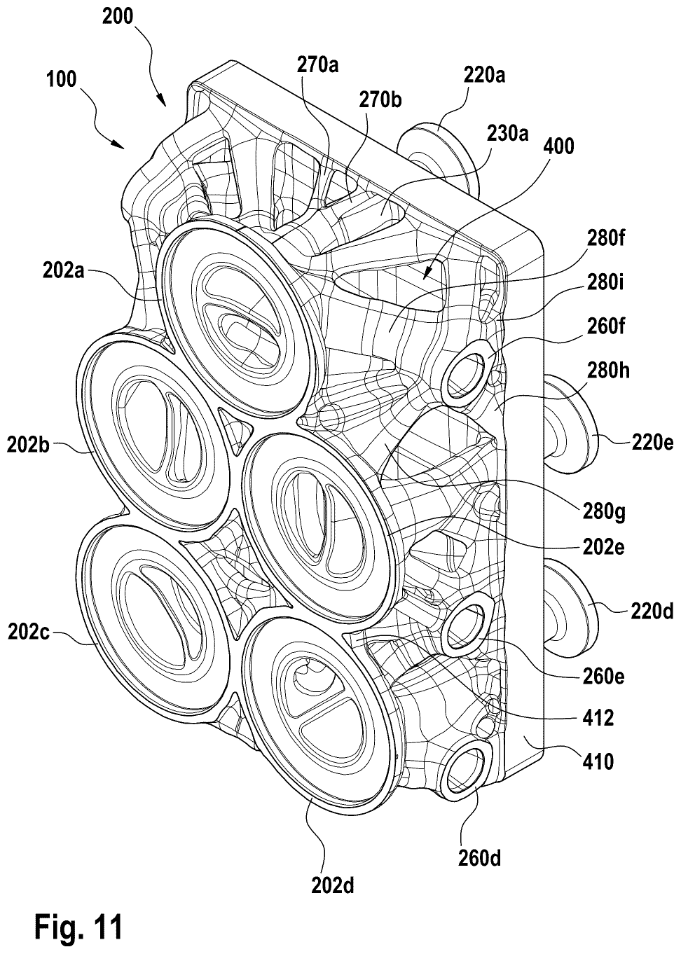

FIG. 11 shows another example of the valve body 100 with a monolithic main body 200 in a perspective plan view of the fastening portions 202a-f. In contrast to FIG. 10, the plate-shaped contour 410 forms a surface that is partially flat at the process fluid connections 220a-e, whereas, starting from the plate-shaped contour 410, in the direction of the base portions 202a-e, the biomimetic structure 400 extends with the other portions of the main body 200 without any further enclosing structure.

The biomimetic structure 400 connects the base portions 202a-b; 202a-e, the fastening portions 260a-c; 260a-f and the tubular walls 230a-c; 230a-f to one another by supporting the biomimetic structure 400 on the plate-shaped contour 410.

The hierarchical support structure comprises parts of the structure 400, wherein main support elements, for example in the form of the tubular wall 230a, branch into smaller support structures such as the tubular support portions 270a-b which are supported on the plate-shaped contour 410. The support structures in the form of the tube support portions 270a-b and the tubular wall thus have the biomimetic branching pattern that is modeled on a natural tree branch structure.

The biomimetic structure 400 provides the three-dimensional network of interconnected structural elements that stabilizes the tubular walls 230a-c; 230a-f, the base portions 202a-b, and the fastening portions 260a-f in various spatial directions, wherein the biomimetic structure 400 has an orientation of the structural elements along the main force flows during operation. For example, the fastening portion 260f is connected to the base portions 202a and 202e using connecting element-like clamping force transmission portions 280f and 280g. Further connecting element-like clamping force transmission portions 280h and 280i connect the fastening portion 260f to the plate-shaped contour 410 in order to introduce the clamping force introduced into the fastening portion 260f as a tensile force into the plate-shaped contour 410.

The clamping force transmission portions 280 extend in a star shape away from the respective fastening portion 260 and thus follow the desired main force directions that develop when a fastening force is introduced into the respective clamping force transmission portion.

The clamping force transmission portions 280 are thus part of the biomimetic structure 400 and connect the fastening portions 260 to the base portions 202 both directly and indirectly via further portions such as the plate-shaped contour 410 in order to enable the transmission of fastening force.

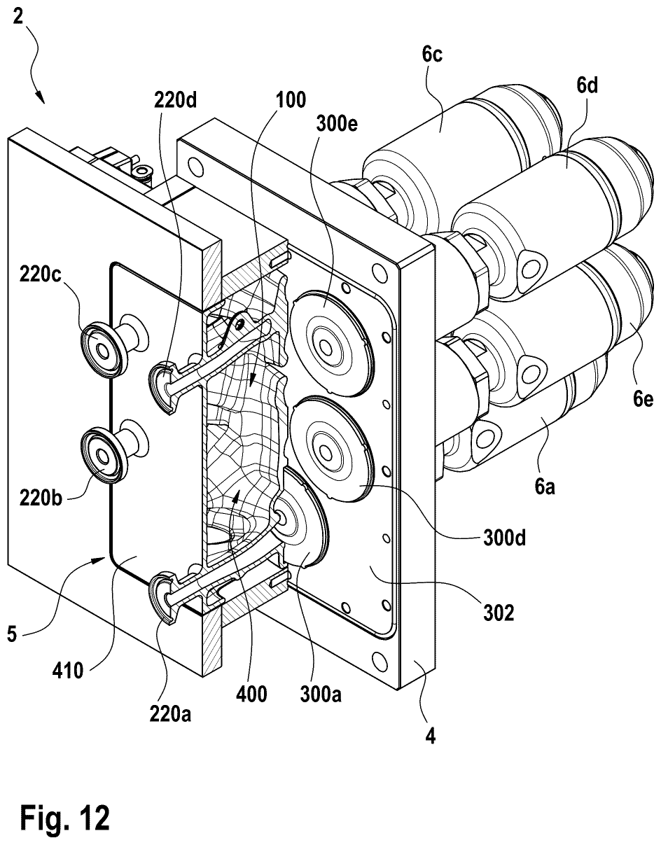

FIG. 12 shows the valve block body 100 from FIG. 11 as part of the fitting assembly 2 in a perspective view. In this example, the valve diaphragms 300a-e are connected via a diaphragm connecting portion 302 and are designed separately from the main body 200.

The connection-side surface of the plate-shaped contour 410 follows a surrounding surface 5 of the drive carrier 4. This not only improves cleanability, but also provides the operating personnel with a uniform visual and tactile appearance. This also improves operation since the process fluid connections are easier to identify due to the concealing of the biomimetic structure 400.

The valve block body disclosed herein provides a lightweight, structurally optimized, and additively manufacturable solution that meets the rigorous demands of single-use and high-purity applications. The biomimetic structuring enables efficient load distribution with reduced material volume, and the modular configuration facilitates integration with drive carriers and valve actuators. These improvements yield cost savings, environmental benefits, and enhanced functional performance.

To the extent not already described, the different features and structures of the various aspects can be used in combination, or in substitution with each other as desired. That one feature is not illustrated in all of the aspects is not meant to be construed that it cannot be so illustrated, but is done for brevity of description. Thus, the various features of the different aspects can be mixed and matched as desired to form new aspects, whether or not the new aspects are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure.

Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A valve block body comprising:
a monolithic main body comprising:
a plurality of base portions, each base portion including a valve seat accessible via a seat opening;
a plurality of fastening portions;
a plurality of process fluid connections;
a plurality of tubular walls, each tubular wall defining an interior of a process fluid channel extending from one of the seat openings toward at least one of the process fluid connections or another seat opening; and
a biomimetic structure that connects the base portions, the fastening portions, and the tubular walls.

2. The valve block body of claim 1, wherein the biomimetic structure has a variable density defined as a ratio of structural material to cavity per unit volume, and includes regions of increased density near the valve seats, the process fluid connections, or the fastening portions, and regions of reduced density between them.

3. The valve block body of claim 1, wherein the biomimetic structure includes a hierarchical support structure comprising main support elements that branch into smaller support structures arranged in a biomimetic branching pattern modeled after a tree branch structure.

4. The valve block body of claim 1, wherein the biomimetic structure forms a three-dimensional network of interconnected structural elements configured to stabilize the tubular walls in multiple spatial directions, with the structural elements oriented along main operational force flows.

5. The valve block body of claim 1, wherein at least two adjacent tubular walls are spaced apart by a continuous cavity such that a skeletal structure of the biomimetic structure is formed between the tubular walls.

6. The valve block body of claim 1, wherein the biomimetic structure includes tubular support portions connecting the tubular walls to the fastening portions.

7. The valve block body of claim 1, wherein the biomimetic structure includes clamping force transmission portions that connect the fastening portions to the base portions to transmit fastening forces.

8. The valve block body of claim 1, further comprising a plurality of valve diaphragms, each closing one of the seat openings.

9. The valve block body of claim 6, wherein the tubular support portions and the clamping force transmission portions are formed by a network of connecting elements and nodes having a variable density, with higher density in regions near the fastening portions and base portions and lower density in central regions of the support and transmission portions.

10. The valve block body of claim 9, wherein the density is further defined by the number of connecting elements per unit volume.

11. The valve block body of claim 1, further comprising a continuous or partially continuous plate-shaped contour located between the process fluid connections and the base portions, wherein the plate-shaped contour is part of or adjoins the biomimetic structure.

12. The valve block body of claim 1, wherein the fastening portions are arranged in a space between the process fluid connections and the base portions.

13. The valve block body of claim 1, wherein a first material-to-cavity ratio of a volume defined by an outer shell of the base portions and the fastening portions is at least 10 percent greater than a second material-to-cavity ratio of a volume defined by the process fluid connections and an outer boundary of the fastening portions or by the plate-shaped contour and the outer boundary of the fastening portions.

14. The valve block body of claim 1, wherein the monolithic main body comprises:
at least one contact surface configured to engage a drive carrier; and
the fastening portions each including a clamping surface facing away from the contact surface for engaging a clamping device, and each base portion providing at least a portion of the contact surface.

15. The valve block body of claim 7, wherein at least one clamping force transmission portion connects a fastening portion and an adjacent base portion, and the base portion provides the contact surface for engagement with the drive carrier.

16. The valve block body of claim 15, wherein the fastening portion is located between a first and a second base portion, a first clamping force transmission portion connects the fastening portion to the first base portion, and a second clamping force transmission portion connects the fastening portion to the second base portion.

17. The valve block body of claim 1, wherein each base portion comprises:
a valve seat;
a seat opening through which the valve seat is accessible;
a diaphragm recess surrounding the seat opening for receiving a valve diaphragm; and
a portion of the contact surface that at least partially surrounds the diaphragm recess.

18. The valve block body of claim 1, wherein the main body includes an outer housing that at least partially encloses the biomimetic structure.

19. The valve block body of claim 1, wherein the biomimetic structure comprises a network of interconnected rod-or plate-shaped connecting elements and nodes, each node connecting at least two connecting elements.

20. The valve block body of claim 1, wherein the main body includes a suspension comprising a tab and a through-opening formed in the tab.

21. A fitting assembly comprising:
the valve block body of claim 1; and
a drive carrier comprising a plurality of valve drives and a clamping device having a plurality of movable clamping elements,
wherein in a first state, the clamping elements release an assembly space for receiving the valve block body, and
in a second state, the clamping elements apply a clamping force to the valve block body via the fastening portions, thereby clamping the valve block body between the clamping elements and the drive carrier.

22. The fitting assembly of claim 21, wherein the clamping elements are actuated by a control carrier movable relative to the valve block body, the valve drives are rigidly mounted on the control carrier, and a clamping drive applies drive force to the control carrier to move it.
